(19) United States
(12) Patent Application Publication
(10) Pub. No.: US 2004/0111417 A1
(43) Pub. Date: Jun. 10, 2004

(54) Data manipulation persisting method in transaction processing system and data manipulating program for remote database

(75) Inventors: Hisasi Goto, Kawasaki (JP); Shigeru Makita, Kawasaki (JP); Tomoaki Yokoyama, Kawasaki (JP)

Correspondence Address: Patrick G. Burns, Esq., GREER, BURNS & CRAIN, LTD., 300 South Wacker Dr., Suite 2500, Chicago, IL, 60606, US

(73) Assignee: FUJITSU LIMITED

(21) Appl. No.: 10/646,305

(22) Filed: Aug. 22, 2003

(30) Foreign Application Priority Data
Aug. 23, 2002 (JP) 2002-243405

(51) Int. Cl. G06F 17/30

(52) U.S. Cl. 707/10

(57) ABSTRACT

A first computer system designates a search condition, requesting a second computer system to retrieve records that satisfy the search condition from a database. The second computer system retrieves all records that satisfy the search condition from the database, sending the contents thereof to the first computer system. The first computer system executes preset data manipulations on a memory to the database object, which corresponds to contents of the retrieved records, recording the contents of the data manipulations into the memory as a log by a record. The first computer system stores the contents of the database object and the log after the data manipulation into a massage, sending it to the second computer system when all preset data manipulations to the database object are completed. The second computer system accesses the database according to the log in the received massage to reflect the database object to the database.

### BACKGROUND OF THE INVENTION

1. Field of the Invention

The present invention relates to a method for persisting data manipulations for a database object in a transaction processing system that consists of a computer system (an application side-site) issuing a data manipulation request and a computer system (a database-side site) accessing the database according to the data manipulation request. Further, the present invention relates to a data manipulating program for a remote database to execute such a data manipulation persisting method in a client computer that communicates with a server computer.

2. Prior Art

In a transaction processing system, an application program to issue data manipulation request for a database according to instructions of an operator is installed in the application-side site. Further, a physical database (a disk) of a database and a data server program accessing the database (the physical database) according to the data manipulation request issued by the application-side site are installed in the database-side site.

An application (a program) executed on the application-side site settles a location of the data server (a program) based on a logical name of the database designated by an operator, establishing connection with the data server and requesting a data manipulation to the database. When the data server to which the data manipulation was requested completes the data manipulation to the database, a processing result (commit or abort) of the data manipulation is returned to the application.

Incidentally, an improvement of performance is an important factor in database processing. Various methods have been adopted conventionally in order to improve a performance.

For example, a stored procedure system has been adopted in general in a system where an application requests a data manipulation to a database for a data server instead of sending every DML (Database Manipulation Language, SQL in a relational database, for example) instruction on an individual basis from an application to a data server to execute the instruction step by step. In the stored procedure system, a stored procedure that is a group of the DML instructions is created and the created stored procedure is registered in the data server. An application calls the stored procedure on the data server to execute.

Since the number of registration of stored procedures should be reduced as few as possible when the stored procedure system is adopted, a special consideration to gather up database access processing is required when a processing logic and a data access logic of an application are designed. Further, if a required procedure of database access is not registered as a stored procedure, it is necessary to send an individual DML instruction from an application to a data server one by one to execute the instruction. Alternatively, the application must cause the data server to execute a stored procedure corresponding to one part of the required procedure and then must cause the data server to execute a different stored procedure corresponding to the remainder of the required procedure.

Even if the stored procedure system is adapted, the communication (a request message and giving and receiving of processing result) between an application and a data server until a persistence of a database object (a content of a record under a data manipulation) becomes complicated when a required procedure of a database access is not registered as a stored procedure. Accordingly, a high-speed, high-performance access to a remote database was difficult to develop in fact.

### SUMMARY OF THE INVENTION

An object of the present invention is to provide a data manipulation persisting method in a transaction processing system and a data manipulating program for a remote databases that enable to minimize communication between an application and a data server until a persistence of a database object regardless of contents of a business operation in order to achieve a high-speed, high-performance access to a remote database without losing degree of freedom of design and programming of a business operation.

According to the data manipulation persisting method in a transaction processing system of the present invention, the first computer system designates a search condition, requesting the second computer system to retrieve records that satisfy the search condition from a database. Then the second computer system retrieves all records that satisfy the search condition designated by the first computer system from the database, sending the contents thereof back to the first computer system. Next, the first computer system executes preset data manipulations on a memory to a database object, which corresponds to contents of the records retrieved by the second computer system, recording the contents of the data manipulations into the memory as a log by a record.

In this way the first computer system stores the contents of the database object and the log after the data manipulations into a message, sending the message to the second computer system when all of the preset data manipulations to the database object are completed. Then the second computer system accesses the database according to the contents of the log in the message received from the first computer system and the second computer system reflects the database object to the database.

A data manipulating program for a remote database of the present invention includes a first step where a client computer, which communicates with a server computer accessing a database to execute transaction for the database, designates a search condition, requesting the server computer to retrieve records that satisfy the search condition from the database.

Next, the data manipulating program includes a second step where the client computer executes preset data manipulations on a memory to a database object, which corresponds to contents of the records retrieved by the server computer, recording the contents of the data manipulations into the memory as a log by a record.

Furthermore, the data manipulating program includes a third step where the client computer stores the contents of the database object and the log after the data manipulations into a message, sending the message to the server computer to reflect the database object to the database when all of the preset data manipulations to the database object are completed. The first, second and third steps mentioned above are executed in this order.

With the method of the present invention, the first computer system (the client computer) communicates with the second computer system (the server computer) to execute various data manipulations to the remote database. However, the second computer system (the server computer) actually accesses the database only when it requests a search and reflects a data manipulation.

Various data manipulations for contents of a record extracted from the database by the search (a database object) are locally executed in the first computer system (the client computer), which does not require communication with the second computer system (the server computer). This means that real accesses to the database are not needed during the data manipulations.

Accordingly, communication between an application and a data server until a persistence of a database object can be minimized regardless of contents of a business operation, which enables to achieve a high-speed, high-performance access to a remote database without losing degree of freedom of design and programming of a business operation.

In the present application, a data manipulation means all of insertion, update and deletion of a record or one part thereof, and movement and copying of a record may be included. A data manipulation may be executed for all of contents of retrieved records (a database object) or for contents selected from the database object. In the latter case, since a log is not recorded about the database object to which data manipulations were not executed, such a database object is not preferably stored in a message that is sent to the second computer system (a server computer) for reflecting data manipulations to the database. This further decreases a quantity of communication.

In addition, when a plurality of data manipulations were executed for the same database object, it is preferable that only the contents after the last data manipulation are stored in a message sent to the second computer system (the server computer) to reflect to the database. This not only decreases a quantity of communication more, but also reduces load of the second computer system (the server computer). The reason is that only one database access is required to the second computer system (the server computer) to reflect the data manipulation.

For the same reason, it is preferable that contents of only one log that is needed to reflect to the database is stored in the message sent to the second computer system (the server computer) when a plurality of data manipulations were executed for the database object. Specifically, when update was executed after insertion for an individual database object, it is preferable that one insertion log and contents after the update are stored in a message.

Further, when deletion was executed after update for an individual database object, it is preferable that one deletion log is stored in a message and contents of the database object is not stored in the message about the database object.

Still further, when deletion was executed after insertion for an individual database object, it is preferable that a log and contents of the database object are not stored in a message about the database object.

### DESCRIPTION OF THE ACCOMPANYING DRAWINGS

FIG. 1 is a block diagram of a transaction processing system as an embodiment of the present invention,

FIG. 2 shows a sample construction of the database included in the system of FIG. 1,

FIG. 3 shows definitions of the database of FIG. 2,

FIG. 4 is a block diagram of a program module of a remote access client,

FIG. 5 is a block diagram of a program module of a data server,

FIG. 6 shows transition of an entry screen that is displayed on a browser by a graphic application,

FIG. 7 is a flowchart showing an example of a business application,

FIG. 8 shows a constitution of a management table,

FIG. 9 is a sequential chart showing communication between a browser and a business application,

FIG. 10 is a sequential chart showing communication between a business application and a database,

FIG. 11 is a flowchart showing a process executed by a remote-process routine when a reflection is requested,

FIG. 12 is a flowchart showing a process executed by an access log manager when a reflection is requested,

FIG. 13 is a flowchart showing a process executed by an access log analyzer,

FIG. 14 shows a format of a remote-process-request message for a search request,

FIG. 15 shows a format of a search-result massage,

FIG. 16 is a table showing a log registration condition by the access log manager,

FIG. 17 shows a format of a log whose manipulation type is update,

FIG. 18 shows a format of a log whose manipulation type is deletion,

FIG. 19 shows a format of a log whose manipulation type is update,

FIG. 20 shows a format of a log whose manipulation type is insertion, and

FIG. 21 shows a format of a remote-process-request message for reflecting a request.

### DESCRIPTION OF THE PREFERRED EMBODIMENTS

An embodiment of the present invention will be described with reference to the drawings.

(System Constitution)

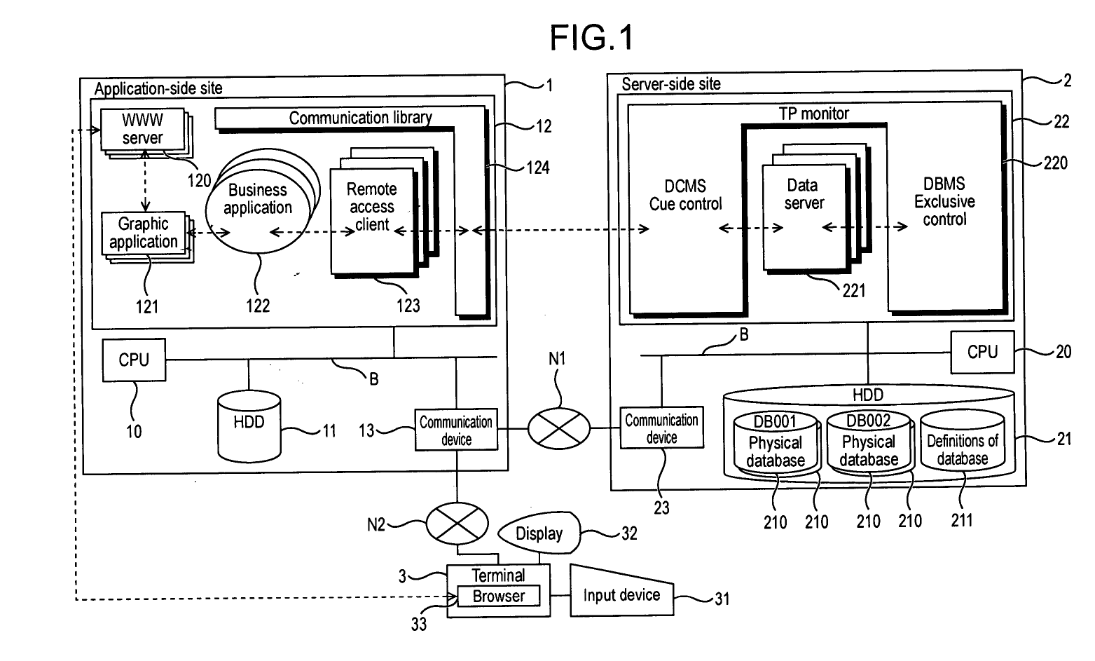

FIG. 1 is a block diagram showing a transaction processing system according to the embodiment of the present invention. As shown in FIG. 1, the transaction processing system is a distributed system that consists of a plurality of computer systems at an application-side site and a server-side site connected through a network N1 such as a local area network (LAN) and a wide area network (WAN). The application-side site 1 can be communicated with a terminal 3 through the Internet N2. In FIG. 1, movements of data among programs described later are shown by dashed lines.

The terminal 3 in FIG. 1 is a general personal computer that can access the Internet. An input device 31 and a display 32 are connected to the terminal 3. A browser program 33 stored in a disk device of the terminal 3 is read and executed by a central processing unit (CPU, not shown) to send an HTTP (Hyper Text Transfer Protocol) request message in which information input through the input device 31 is stored to the application-side site 1 through the Internet N2. The browser program 33 displays information based on a Web data (HTML (Hyper Text Markup Language) data, for example), which is stored in a HTTP response massage corresponding to the HTTP request message, on the display 32.

In addition, the application-side site 1 (a first computer system, a client computer) consists of one or more application server devices that are constructed to support business (only one device is illustrated in FIG. 1). The application-side site 1 is provided with a CPU 10, a hard disk drive (HDD) 11, a random access memory (RAM) 12 and a communication device 13 as principal elements, which are connected one another through buses (a system bus and a data bus) B. The CPU 10 controls the entire system of the application-side site 1. Further, the RAM 12 is a main memory on which a working area is developed when the CPU 10 executes various processes. Still further, the communication device 13 is a physical interface to the network N1 and to the line on which the Internet N2 is constructed (Internet backbone). Yet further, the HDD 11 is one or more external storage units that store various programs and various data read and executed by the CPU 10.

Programs for an operating system (not shown), a WWW server 120, a graphic application 121, a business application 122, a remote access client 123 and a communication library 124 are stored in the HDD 11. These programs are developed on the RAM 12 and executed by the CPU 10. The WWW servers 120 are executed on the RAM 12 based on a single program stored in the HDD 11. The WWW servers 120 are executed independently to one another for the respective browsers 33 of the terminals 3 that are accessing the application-side site 1.

Further, the graphic application 121 consists of a plurality of programs prepared for the respective processing targets. These programs are read onto the RAM 12 by the respective WWW servers 120, being executed independently.

In addition, the business application 122 includes a plurality of programs prepared for the respective processing targets. These programs are read onto the RAM 12 and executed independently. Still further, the remote access clients 123 are executed independently to one another on the RAM 12 by the respective business applications 122 based on a single program stored in the HDD 11.

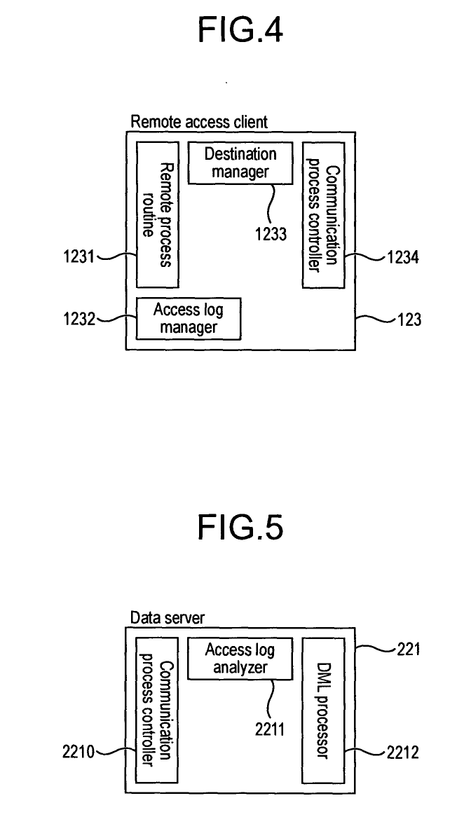

As shown in FIG. 4, each remote access client 123 consists of a remote-process routine 1231, an access log manager 1232, a destination manager 1233 and a communication process controller 1234. The functions of the WWW server 120, the graphic application 121, the business application 122, the remote access client 123 (the remote-process routine 1231, the access log manager 1232, the destination manager 1233 and the communication process controller 1234) and the communication library 124 will be described latter.

The server-side site 2 (the second computer system, a server computer) is a fundamental server machine that stores the database or consists of a plurality of server machines that form a distributed system whose consistency is guaranteed with two-phase commit of a transaction manager (not shown). The server-side site 2 is provided with a central processing unit (CPU) 20, a hard disk drive (HDD) 21, a random access memory (RAM) 22 and a communication device 23 as principal elements, which are connected to one another through buses (a system bus and a data bus) B. The CPU 20 controls the entire system of the server-side site 2. Further, the RAM 22 is a main memory on which a working area is developed when the CPU 20 executes various processes. Still further, the communication device 23 is a physical interface to the network N1. Furthermore, the HDD 21 is one or more external storage units that store various programs and various data read and executed by the CPU 20.

In the HDD 21, one or more physical databases 210 (two databases whose database logic names are DB001 and DB002 in FIG. 1) and definition information 221 that defines structures of the databases DB001 and DB002 (a record name, a data field name, a data type of each field) are stored.

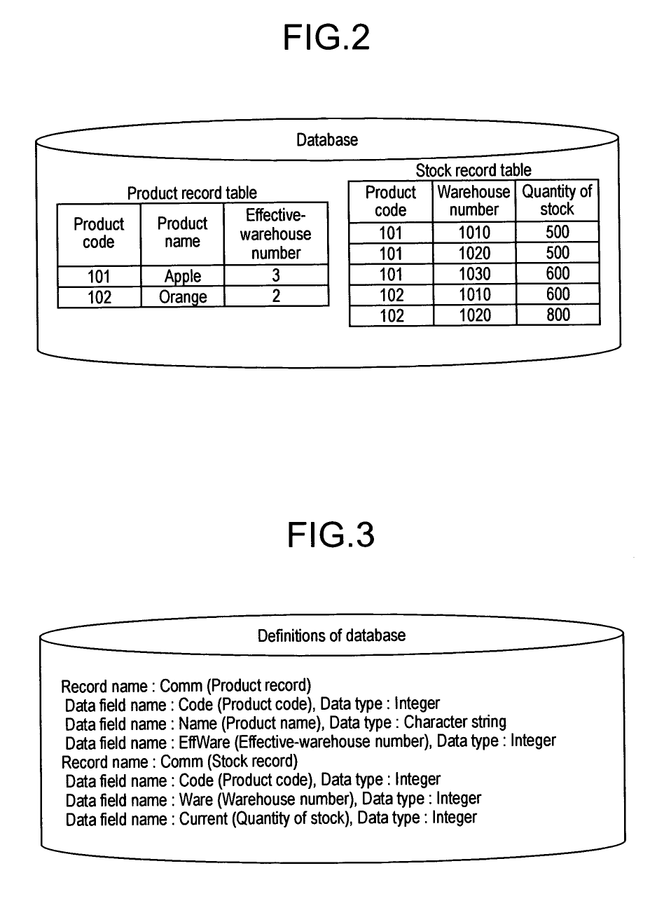

FIG. 2 is a logical (visual) outline showing a sample structure of one database and FIG. 3 shows contents of the definition information 221 about the database shown in FIG. 2. This database consists of a product record table containing one or more (two in FIG. 2) records whose record name is “a product record” and a stock record table containing one or more (five in FIG. 2) records whose record name is “a stock record” as shown in FIGS. 2 and 3. The product record includes a “product code” field whose data type is an integer, a “product name” field whose data type is character string and an “effective warehouse number” field whose data type is an integer. The stock table includes a “product code” field whose data type is an integer, a “warehouse number” field whose data type is an integer and a “quantity of stock” field whose data type is an integer.

In FIG. 1, there are a plurality of physical databases for each of the logical databases DB001 and DB002. This shows that one logical database is stored in a plurality of disk devices or that a mirror disk structure is adapted as insurance against troubles.

Programs for an operating system (not shown), a transaction processing (TP) monitor 220 and a data server 221 are stored in the HDD 21. These programs are developed on the RAM 22 and executed by the CPU 20. The data servers 221 are executed independently to one another on the RAM 22 based on a single program stored in the HDD 21. As shown in FIG. 5, each data server 221 consists of a communication process controller 2210, an access log analyzer 2211 and a DML processor 2212. The functions of the TP monitor 220, the data server 221 (the communication processor 2210, the access log analyzer 2211 and the DML processor 2212) will be described latter.

Next, contents of the respective programs executed in the application-side site 1 will be described.

The WWW server 120 replies to an HTTP request message received from the browser 33 of each terminal 3, sending back Web data. When the HTTP request message is a process request corresponding to any business, the graphic application 121 corresponding to the business is started.

The graphic application 121 is a servelet working on a JAVA (a trademark of Sun Microsystems in USA) virtual machine, interacting with the browser 33 using HTTP. That is, the graphic application 121 sends the HTML data to display various input screens having one or more item-input boxes and obtains information input into the item-input boxes. The graphic application 121 collects parameters required of the business operations (data manipulations for each database) from the browser 33 to send the parameters to the business application 122, returning a processing result by the business application 122 to the browser 33.

The business application 122 is an aplet working on a JAVA virtual machine to request the remote access client 123 to retrieve records based on the parameters that are collected from the browser 33 by the graphic application 121. The remote access client 123 requests to retrieve records from the server-side site 2 (the data server 221), getting search results.

Further, the business application 122 executes data manipulations (update, deletion or insertion of records) for the contents of the records (a database object) received from the remote access client 123 as a result of the record search. Then the business application 122 requests the remote access client 123 to reflect the result of the data manipulation to the database to be searched.

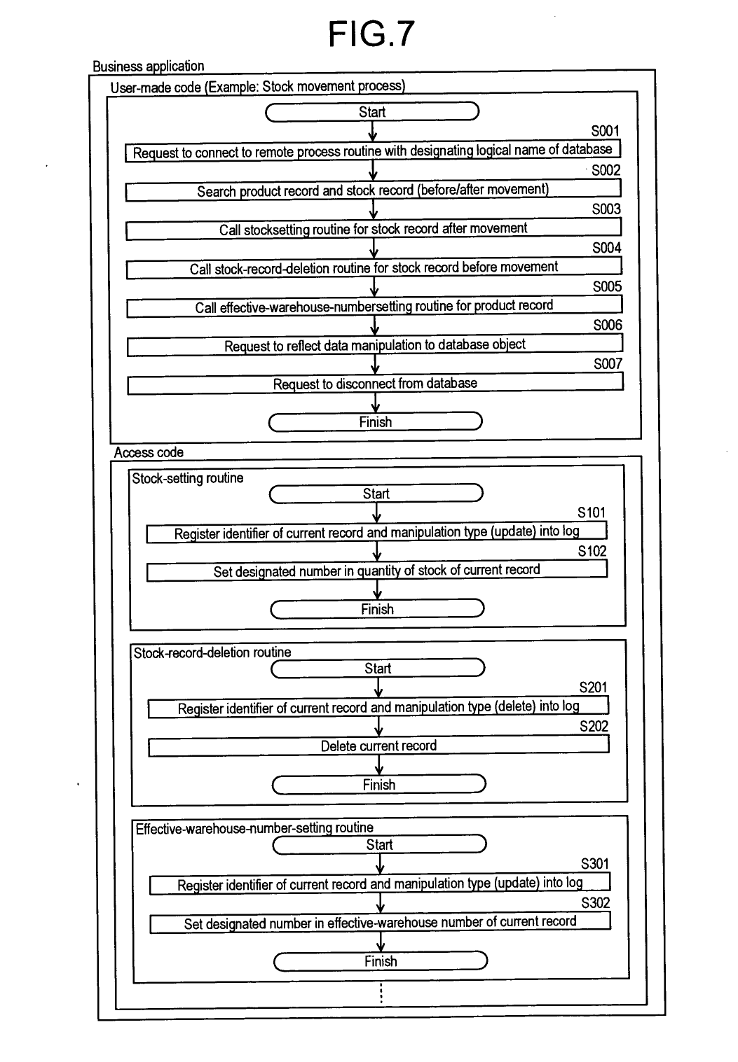

As shown in FIG. 7, each business application 122 consists of an access code that consists of various data manipulating routines provided by the server-side site 2 corresponding to the structure of the target database of the business operation and a user-generated code that is independently programmed at the application-side site 1 in order to execute concrete data manipulations for a database object by the use of the access code. Various data manipulation routines comprising the access code are programs (source codes described in the same programming language as the business application, i.e., the user-generated code) that are automatically created by a dedicated tool at the server-side site 2 in advance based on the definitions of the target database of the business. In the example of FIG. 7, the access code includes a stock-setting routine and a stock-record-deletion routine for the stock records, and an effective-warehouse-number-setting routine for the product records that are created based on the definition information shown in FIG. 2. Further, the user-generated code is a program to execute a stock movement process by the use of the access code.

Contents of concrete data manipulations were programmed as a family of DML instructions in a conventional stored procedure system. On the other hand, they are programmed in a general-purpose programming language (JAVA) in the business application (the access code and the user-generated code) in the present embodiment.

The remote access client 123 honors a processing request (a connection request, a request to search a database, a request to reflect data manipulations, a disconnection request) from the business application 122, issuing the request to the data server 221.

The communication process controller 1234 of the remote access client 123 controls data communication between the remote access client 123 and each data server 221.

The access log manager 1232 runs when it is called by each data manipulation routine of the user-generated code at every manipulation in order to record and manage contents of concrete data manipulations to a database object by the business application 122 in chronological order as a log.

The remote-process routine 1231 honors remote processing requests such as a request to connect to the database, a request to disconnect from the database, a request to search the database and a request to reflect the contents of the data manipulations to the database object for the database, sending the remote processing massage to the data server. When a process type of the remote processing request for the database from the business application 122 was “a reflection request”, a log recorded by the access log manager 1232 is encoded and stored in the remote-process-request massage.

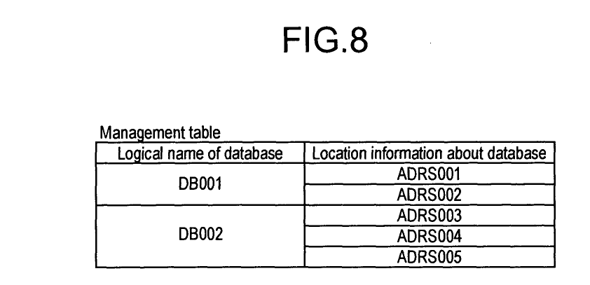

The destination manager 1233 is called by the communication process controller 1234 when the remote-process routine 121 accepts a request to connect to the database from the business application 122, settling an address (location) of the data server 221 corresponding to the database based on the logical name of the database designated by the business application 122. The destination manager 1233 refers to a management table shown in FIG. 8 when an address of the data server 221 is settled. The management table includes addresses (locations) of one or more data servers 211 that have qualifications to access the database for every database logic name. The management table is created by a system manager at the time of system configuration.

Each data server 221 executes various remote processing requests received from the business application 122 through the remote access client 123.

The communication process controller 2210 of the data server 221 controls data communication between the data server 221 and the remote access client 123. When the process type of the remote-process-request message is “a connection/disconnection request” or “a search request”, the communication process controller 2210 passes the remote-process-request message to the DML processor 2212.

Further, when the process type is “a reflection request”, the communication process controller 2210 passes the remote-process-request message to the access log analyzer 2211. The access log analyzer 2211 requests the DML processor 2212 to execute a database access (update, insertion or deletion of records) according to the contents of the log encoded in the remote-process-request message that is received from the communication process controller 2210 for a reflection request.

The DML processor 2212 prepares a DML instruction that is suitable for executing the requested contents (a type of a DML instruction and parameters are set adequately) based on the contents of the remote-process-request massage received from the communication process controller 2210 (connection/disconnection or search) or based on the contents requested by the access log analyzer 2211 (update, insertion or deletion of records). Then, the DML processor 2212 accesses the database to execute the prepared DML instructions.

The TP monitor 220 has a function of a data communication management system (DCMS) that includes a cue control for cueing a database connection request from the application-side site 1 to dispatch the connection request to the data server 211 corresponding to the target database of the connection request. Further, the TP monitor 220 has a function of a database management system (DBMS) that includes an exclusive control for locking an in-access record of a database until a transaction commits.

### OPERATION EXAMPLE

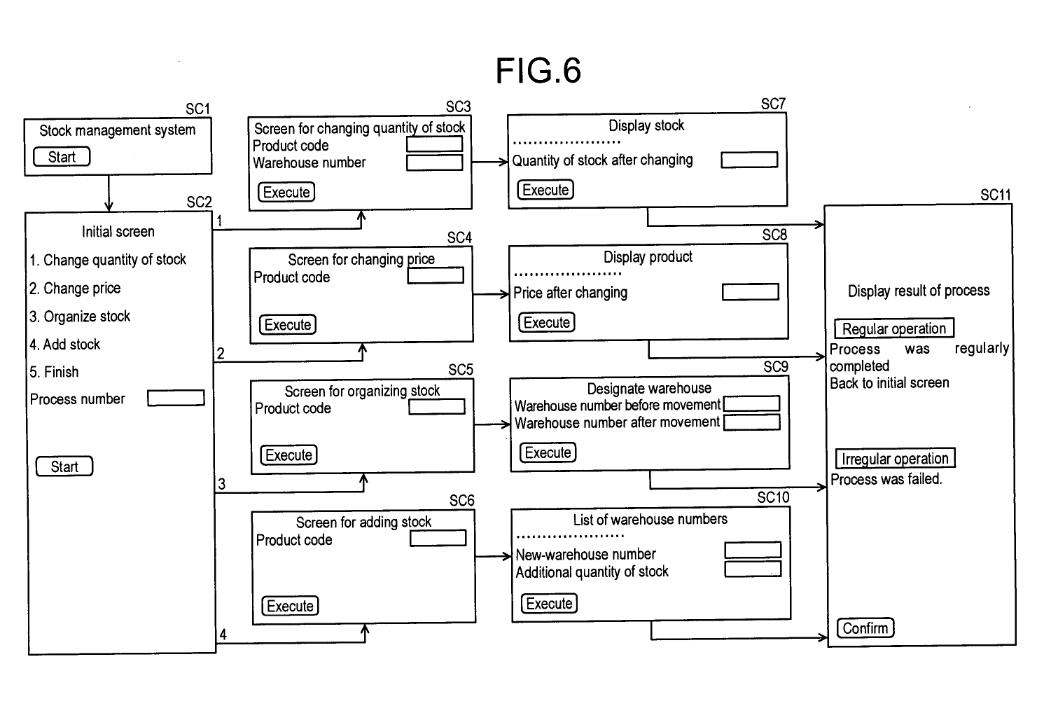

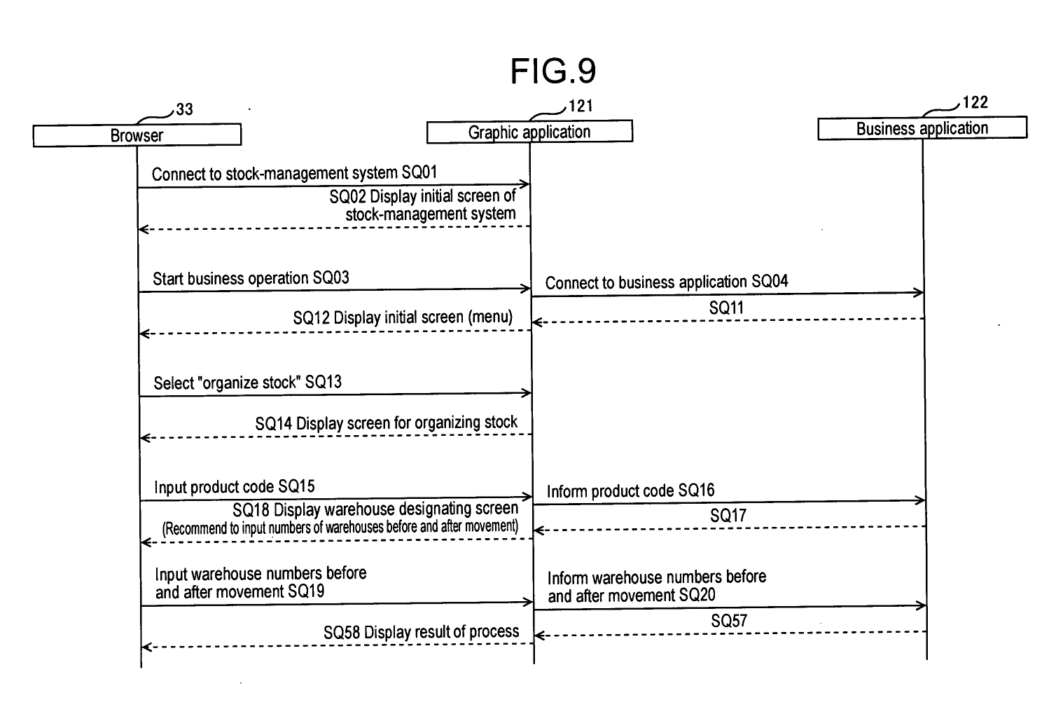

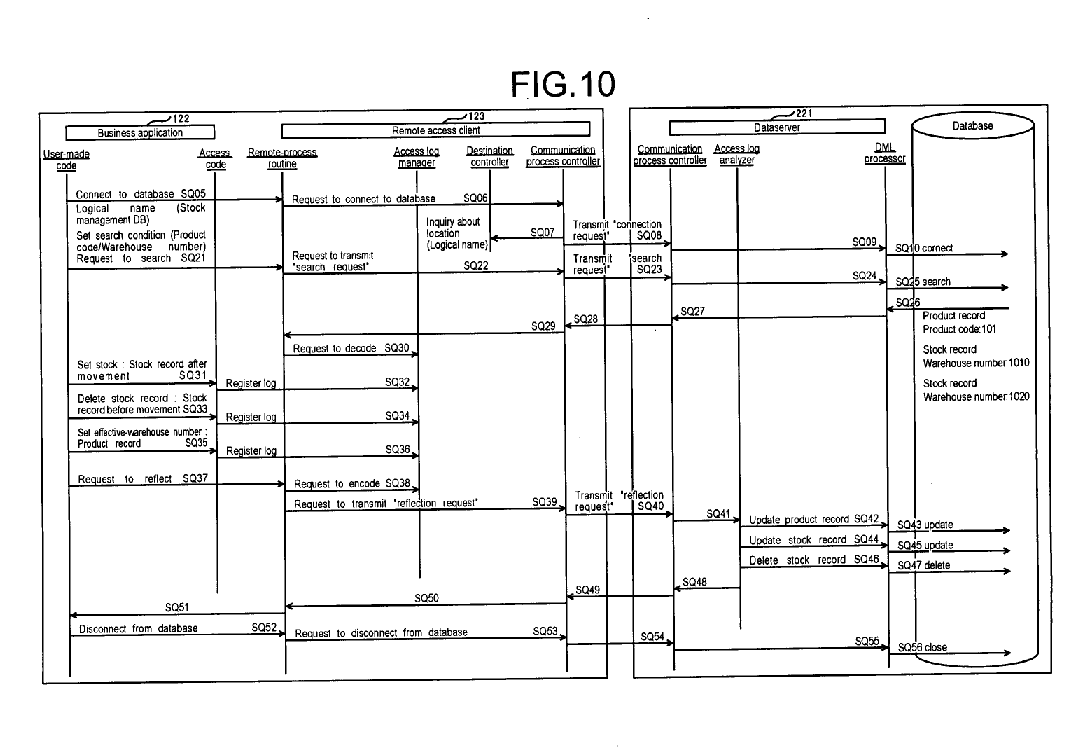

Operation examples of the above described programs will be described hereinafter with reference to sequential charts in FIGS. 9 and 10, and flowcharts in FIG. 7 and FIGS. 11 through 13. It is assumed that the database stored in the HDD 21 of the server-side site 2 has structure shown in FIG. 2. Further, it is assumed that the graphic application 121 makes the browser 33 display various input screens shown in FIG. 6. Furthermore, it is assumed that the business application 122 executes processing contents shown in FIG. 7.

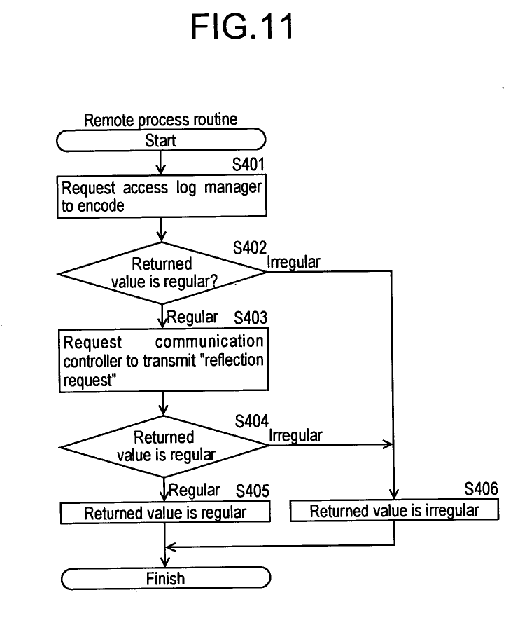

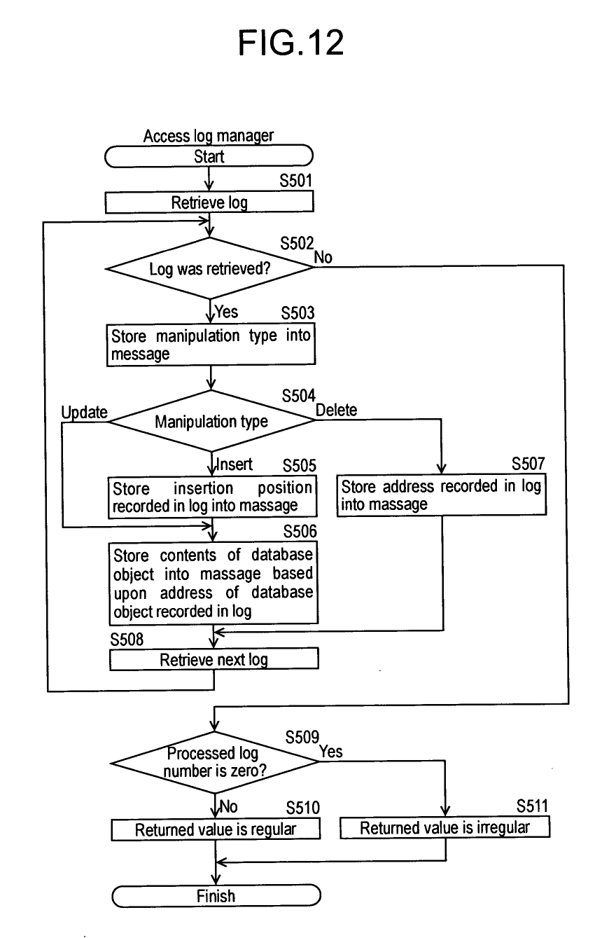

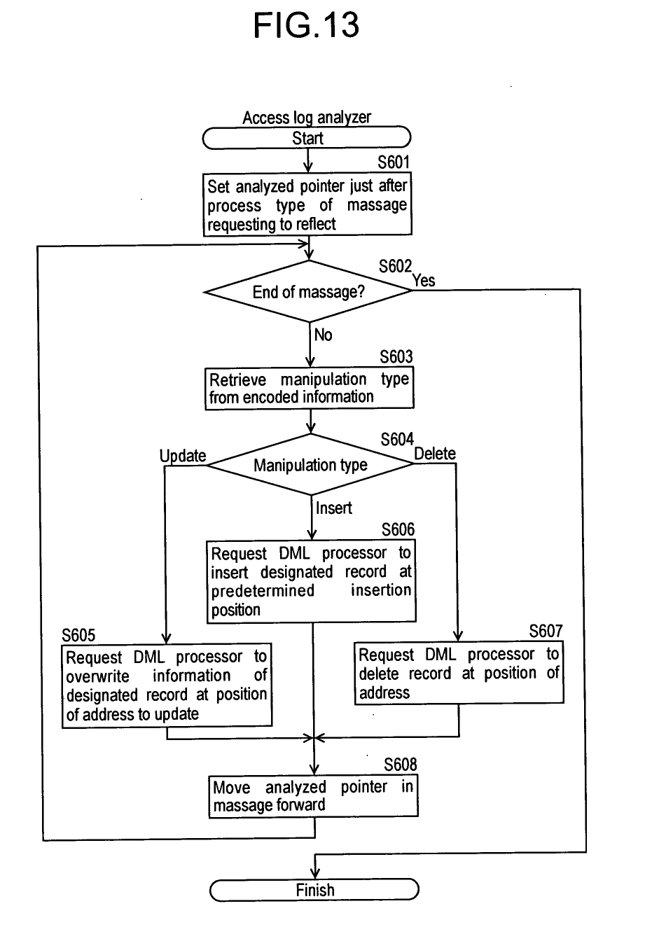

FIG. 9 is a sequential chart showing communication among the browser 33, the graphic application 121 and the business application 122. FIG. 10 is a sequential chart showing communication among the business application 122, the remote access client 123, the data server 221 and the database. FIG. 11 is a flowchart showing a process of the remote-process routine 1231 when a reflection is requested. FIG. 12 is a flowchart showing a process of the access log manager 1232 when a reflection is requested. FIG. 13 is a flowchart showing a process of the access log analyzer 2211.

The following descriptions are built on premises that the browser 33 sends a HTTP request message, which designates the URL corresponding to a predetermined business operation or a stock management, to the WWW server 120. In this case, the WWW server 120 starts the graphic application 121 corresponding to the business operation “stock management”, connecting to the browser 33 from which the request was issued. That is, the browser 33 connects to the stock-management system (SQ01). The graphic application 121 makes the browser 33 display a start screen SC1 of a stock-management system (SQ02). When an operator clicks a “start” button on the start screen SC1 by operating the input device 31, the browser 33 sends a business-operation-start request to the graphic application 121 (SQ03). The graphic application 121 that received the business-operation-start request starts the business application 122 corresponding to the business operation and connects the started business application 122 (SQ04).

The started business application 122 (a user-generated code) designates a logical name of a database corresponding to its business operation to send a connection request to the remote-process routine 1231 after the business application 122 starts the remote access client 123 (S001, SQ05). The remote-process routine 1231 requests the communication process controller 1234 to connect to the database using the designated logical name thereof as a call parameter (SQ06). The communication process controller 1234 calls the destination manager 1233 to make inquiry about an address (location) of the data server 221 corresponding to the designated logical name of the database (SQ07). The destination manager 1233 refers to the management table shown in FIG. 8 to settle the location of the data server 221 corresponding to the logical name. A system manager selects a method to settle the location from the following methods. The first method settles the location by distributing the data servers 221 by unit of the terminal 3 from which the request was issued. The second method settles the location by distributing the data server 221 for the respective honored connection requests in a round-robin fashion. The third method settles the location by monitoring loads of the data servers 122 to select an unallocated data server 122.

The communication process controller 1234 transmits a remote-process-request massage whose process type is a “connection request” to an address (a location) of the data server 221 settled by the destination manager 1233 (SQ08). The communication process controller 2210 of the data server 221 that received the remote-process-request message passes this remote-process-request message to the DML processor 2212 (SQ09). The DML processor 2212 that received the remote-process-request massage issues an appropriate DML instruction to connect to the database, starting transaction of database process (SQ10).

When a connection with the database is completed, the business application 122 acknowledges completion of connection to the graphic application 121 (SQ11). Then graphic application 121 makes the browser 33 display the initial screen SC2 (SQ12). When an operator clicks the “start” button after he or she inputs a number corresponding to the business in an input box of the initial screen SC2, the browser 33 transmits the number in the input box to the graphic application 121.

Here, it is assumed that a product whose product code is “101” (an apple) is moved from a warehouse whose warehouse number is “1020” to a warehouse whose warehouse number is “1010”. In this case, an operator sets number “3” corresponding to “organize stock”: the graphic application 121 makes the browser 33 display a screen for organizing stock SC5 (SQ14). When an operator clicks an “execute” button after he or she inputs the product code in an input box of the screen for organizing stock SC5, the browser 33 transmits the product code in the input box to the graphic application 121 (SQ15). The graphic application 121 informs the product code received from the browser 33 to the business application 122 (SQ16).

When the business application 122 acknowledges safe receipt of the product code to the graphic application 121 (SQ17), the graphic application 121 makes the browser 33 display a warehouse designating screen SC9 to recommend to input numbers of warehouses before and after movement (SQ18). When an operator clicks an “execute” button after he or she inputs a warehouse number before movement and a warehouse number after movement in input boxes of the warehouse designating screen SC9, the browser 33 transmits the warehouse numbers in the input boxes to the graphic application 121 (SQ19). The graphic application 121 informs the warehouse numbers before and after movement received from the browser 33 to the business application 122 (SQ20).

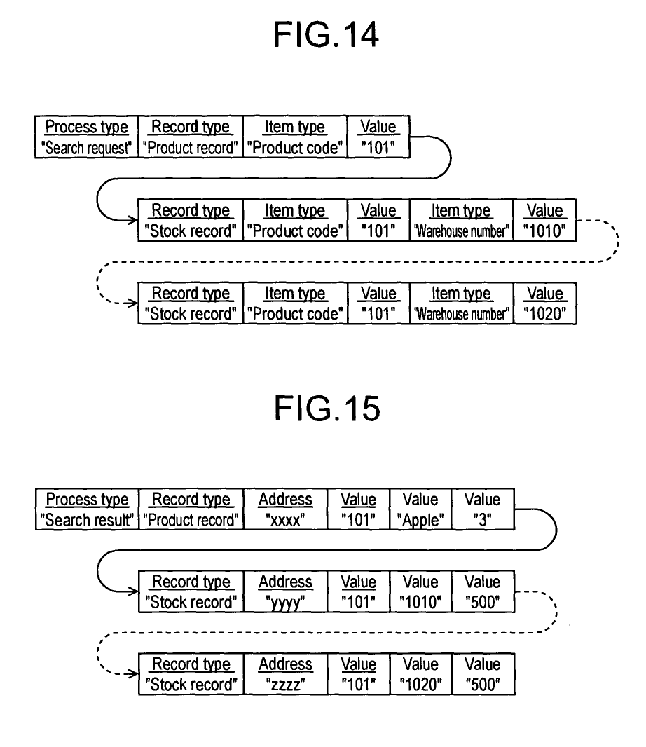

The business application 122 (user-generated code) gets the information about the product code and the warehouse numbers before and after movement as described above, informing a database-search request to the remote-process routine 1231 with setting the information (the product code and the warehouse numbers) as search condition (S002, SQ21). The remote-process routine 1231 creates a remote-process-request massage including the search condition whose process type is a “search request”, requesting the communication processing controller 1234 to send the massage to the data server 221 (SQ22). FIG. 14 shows a format of a remote-process-request massage. As shown in FIG. 14, the remote-process-request massage described in this embodiment includes a process type “search request” in the top. The massage also includes a record type and the search condition (a field type and a value) designated for every record to be retrieved. A field type designated as a search condition may be specified by using flags. With this method, flags corresponding to all of the fields should be defined first. Then the flags corresponding to the designated fields are set (TRUE, 1) and the flags corresponding to the non-designated fields are reset (FALSE, 0). The communication process controller 1234 transmits the remote-process-request massage received from the remote-process routine 1231 to the communication process controller 2210 of the data server 221 (SQ23).

The communication process controller 2210 of the data server 221 passes the received remote-process-request massage to the DML processor 2212 (SQ24). The DML processor 2212 that received the remote-process-request massage issues an appropriate DML instruction to search a database as requested by the remote-process-request massage (SQ25). As a result, a product record having a product code “101”, a stock record having a product code “101” and a warehouse number “1010”, and a stock record having a product code “101” and a warehouse number “1020” are extracted (SQ26). Each record that is extracted from a database is transmitted from the DML processor 2212 to the communication process controller 2210 (SQ27). The communication process controller 2210 stores the received records in a search-result massage and sends back a response to the remote access client 123 (SQ28). A format of the search-result massage in this case is shown in FIG. 15. As shown in FIG. 15, the format of the search-result massage described in this embodiment includes a process type “search result” in the top. The massage also includes a record type, the address of the record in the database and all values in the record for every extracted record. The process type and contents of the extracted records are continued in the massage. In this embodiment, since the values of all fields in every record are informed, each data manipulation routine, which constitutes the access code of the business application 122, can recognize the field type (an attribute) of each value even if a message does not include a field type.

The communication process controller 1234 transfers the search-result massage received to the remote-process routine 1231 (SQ29). Then the remote-process routine 1231 requests the access log manager 1232 to decode each of the records (a product record having a product code “101”, a stock record having a product code “101” and a warehouse number “1010”, and a stock record having a product code “101” and a warehouse number “1020”) included in the search result massage (SQ30). The access log manager 1232 that received the request creates a database object corresponding to these records in an address space of the business application 122. The database object created at the time stores the addresses of the records, which are included in the search-result massage, in the database. Search results are informed to the business application 122 by creating the database object.

The business application 122 (user-generated code) that acquired the database object calls a stock setting routine for the stock record included in the access code. The business application 122 makes the stock setting routine execute a data manipulation “update” to a database object corresponding to a stock record after movement (a stock record having a product code “101” and a warehouse number after movement “1010”) (S003, SQ31).

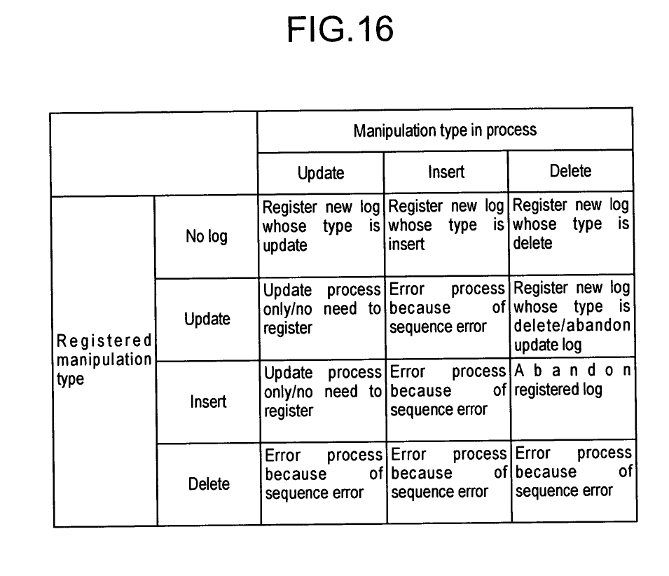

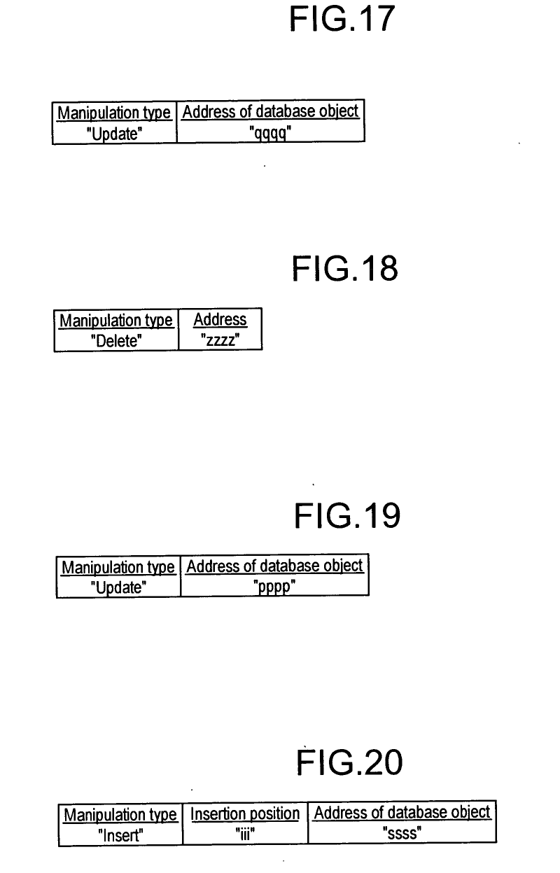

The stock setting routine for the stock record called by the business application 122 passes the address of the database object created in the address space of the business application 122 corresponding to the current stock record after movement and a manipulation type “update” to the access log manager 1232 as parameters, requesting to register the address (an identifier of the current record) and the manipulation type “update” in a log (S101, SQ32). The access log manager 1232 that received the request executes the process corresponding to a manipulation type defined in a registered log and a manipulation type of the current request about the current database object according to a table shown in FIG. 16. For example, when there is no registered log about the current database object, the access log manager 1232 newly registers a log whose manipulation type is “update” because the manipulation type in the current request is “update”. FIG. 17 shows a format of the log whose manipulation type is “update”. As shown in FIG. 17, the log includes a manipulation type “update” and an address of a database object.

Next, the stock setting routine for the stock record sets a designated number in the field “quantity of stock” of a database object about a stock record after movement (S102). For example, a value “1000”, which is a sum of an existing value “500” of the “quantity of stock” field of the stock record after movement and a value “500” of the “quantity of stock” field of the stock record before movement, is written over the “quantity of stock” field of the stock record after movement.

When the stock setting routine for the stock record finishes its process, the business application 122 (user-generated code) calls a stock-record-deletion routine included in the access code. Then, the business application 122 makes the stock-record-deletion routine execute a data manipulation “deletion” to a database object corresponding to a stock record before movement (the stock record having a product code “101” and a warehouse number before movement “1020”) (S004, SQ33).

The stock-record-deletion routine called by the business application 122 passes the address specifying a location of the stock record before movement in the database and a manipulation type “deletion” to the access log manager 1232 as parameters, requesting to register the address (an identifier of the current record) and the manipulation type “deletion” in a log (S201, SQ34). The access log manager 1232 that received the request executes the process corresponding to a manipulation type defined in a registered log and a manipulation type of the current request about the current database object according to the table shown in FIG. 16. Since there is no registered log about the current database object and the manipulation type in the current request is “deletion”, the access log manager 1232 newly registers a log whose manipulation type is “deletion”. FIG. 18 shows a format of the log whose manipulation type is “deletion”. As shown in FIG. 18, the log includes a manipulation type “deletion” and an address of the stock record before movement in the database that is read from the current database object.

Next, the stock-record-deletion routine deletes the database object about the current stock record before movement (S202).

When the stock-record-deletion routine finishes the process, the business application 122 (user-generated code) calls an effective-warehouse-number setting routine for the product record included in the access code. Then, the business application 122 makes the effective-warehouse-number setting routine execute a data manipulation “update”to a database object corresponding to the product record having a product code “101” (S005, SQ35).

The effective-warehouse number setting routine called by the business application 122 passes the address of the database object created in the address space of the business application 122 corresponding to the current product record and a manipulation type “update” to the access log manager 1232 as parameters, requesting registration of a log (S301, SQ36). The access log manager 1232 that received the request executes the process corresponding to a manipulation type defined in a registered log and a manipulation type of the current request about the current database object according to a table shown in FIG. 16. Since there is no registered log about the current database object and the manipulation type in the current request is “update”, the access log manager 1232 newly registers a log whose manipulation type is “update”. FIG. 19 shows a format of the log whose manipulation type is “update.” As shown in FIG. 19, the log includes a manipulation type “update” and an address of a database object.

Next, the effective-warehouse-number setting routine for the product record sets a designated number in the “effective-warehouse number” field of a database object about the current product record (S302). A value “2” is written over the existing value “3” in the “effective-warehouse number” field of the database object about the current product record after a decrement by one.

Although the user-generated code of the business application 122 shown in FIG. 7 uses only three data manipulation routines of the access code, the access code includes a data insertion routine for creating a new record to be added to a database. For example, when an operation “add stock” is selected in the initial screen SC2 and then an “execute” button is clicked in a screen of a list of warehouse numbers SC10 that is displayed after the initial screen SC2, the business application utilizes the record insertion routine. FIG. 20 shows a format of a log registered by the access log manager 1232 after the record insertion routine is executed (when there is no registered log about the target database object). As shown in FIG. 20, the log includes a manipulation type “insertion”, a position at which a new record should be inserted in a database and an address of the database object corresponding to the new record.

The above described operations finish the data manipulations to the database object about the current business and the stock organization. After that, the business application 122 (user-generated code) requests the remote-process routine 1231 of the remote access client 123 to reflect the data manipulations executed with respect to the current business and the stock organization (S006, SQ37). Then the remote-process routine 1231 requests the access log manager 1232 to encode the database object and the series of logs about the current business and the stock organization into the remote-process-request massage according to a flowchart shown in FIG. 11 (S401, SQ38).

The access log manager 1232 that received the request tries to retrieve the log about the current business at S501 of FIG. 12. Next, the access log manager 1232 checks whether a log was retrieved or not in S101 (S502). When a log was retrieved, the access log manager 1232 stores the manipulation type in the log into a remote-process-request massage for a reflection request (S503). At the top of the remote-process-request message, “a reflection request” is set as a process type.

Next, the access log manager 1232 distinguishes the manipulation type stored in the remote-process-request massage at S504. If the manipulation type is “insertion”, the process goes on to S508 through S505 and S506. If the manipulation type is “update”, the process goes no to S508 through S506. If the manipulation type is “deletion”, the process goes no to S508 through S507.

At S505, the access log manager 1232 reads the insertion position recorded in the log and stores it into the remote-process-request massage. At S506, the access log manager 1232 reads the contents of the database object (values of all fields in the record and an address of the record in the database for update) based on an address of a database object recorded in the log, storing them into the remote-process-request message. At S507, the access log manager 1232 stores an address defined in the log into the remote-process-request massage. At S508, the access log manager 1232 returns the process to S502 after trying to retrieve the next log.

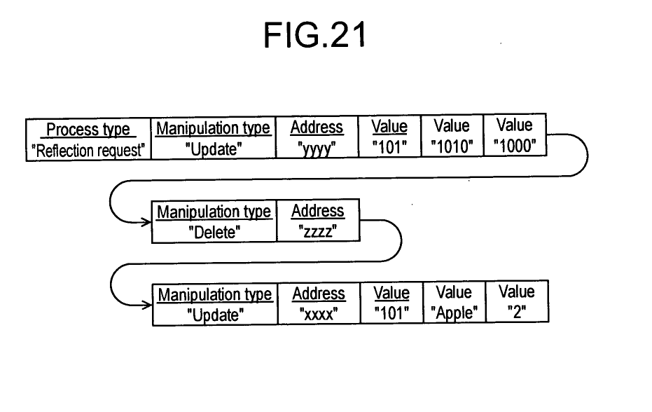

The access log manager 1232 proceeds with the process from S502 to S509 when the log is not retrieved as a result of repeating the process loop from S502 through S508 or when no log is retrieved from the beginning. At S509, the access log manager 1232 checks whether the number of the logs retrieved to be processed is zero or not. If the number of processed log is not zero, the access log manager 1232 sets a returned value to “regular” at S510, returning the remote-process-request massage created to reflect a request and the returned value to the remote-process routine 1231. If the number of processed log is zero, the access log manager 1232 sets a returned value to “irregular” at S511, returning the returned value to the remote-process routine 1231. FIG. 21 shows a remote-process-request massage created based on a series of logs created as a result of executions of the business application 122 shown in FIG. 7 for requesting to reflect.

The remote-process routine 1231 checks whether the returned value is “regular” or not (S402). If the returned value from the access log manager 1232 is “irregular”, the remote-process routine 1231 sets a returned value to “irregular” for the business application 122 (S406, SQ51). On the other hand, if the returned value from the access log manager 1232 is “regular”, the remote-process routine 1231 requests the communication process controller 1234 to transmit the remote-process-request massage for a reflection request received from the access log manager 1232 to the data server 221 (S403, SQ39).

The communication process controller 1234 transmits the remote-process-request message for the reflection request to the communication process controller 2210 of the data server 221 (SQ40). The communication process controller 2210 that received the remote-process-request message for reflection request passes this massage to the access log analyzer 2211.

The access log analyzer 2211 that received the remote-process-request message for the reflection request sets an analyzed pointer just after the process type in the remote-process-request massage (the massage requesting to reflect) according to the flowchart shown in FIG. 13 (S601). Next, the access log analyzer 2211 checks whether the analyzed pointer is located at the end position in the remote-process-request massage or not (S602). When the analyzed pointer is not located on the end position of the remote-process-request massage, that is, when no-analyzed log-unit-encode information (information between one process type and the next process type) still remains, the access log analyzer 2211 retrieves a manipulation type from log-unit-encode information just after the pointer at S603. Next, the access log analyzer 2211 distinguishes the manipulation type retrieved at S603 (S604). If the manipulation type is “update”, the process goes on to S605. The process goes on to S606 if the manipulation type is “insertion” and to S607 if the manipulation type is “deletion.”

At S605, the access log analyzer 2211 requests the DML processor 2212 to update the record of the database by overwriting the existing data at a position in the database that is defined by the address in the log-unit-encode information following the manipulation type retrieved at S603 with the contents of the database object in the log-unit-encode information (SQ42, SQ44). The DML processor 2212 that received the request issues an appropriate DML instruction to update a record (SQ43, SQ45).

At S606, the access log analyzer 2211 requests the DML processor 2212 to insert the contents of the database object as a record at a position in the database that is defined by the address in the log-unit-encode information following the manipulation type retrieved at S603. The DML processor 2212 that received the request issues an appropriate DML instruction to insert a record as requested.

At S607, the access log analyzer 2211 requests the DML processor 2212 to delete the record at a position in the database that is defined by the address in the log-unit-encode information following the manipulation type retrieved at S603 (SQ46). The DML processor 2212 that received the request issues an appropriate DML instruction to delete a record as requested (SQ47).

When the process at S605, S606 or S607 is completed, the access log analyzer 2211 moves the analyzed pointer to the end of the log-unit-encode information that has been processed at S608, returning the process to S602.

The access log analyzer 2211 repeats the loop from S602 to S608 until the analyzed pointer reaches the end of the remote-process-request message. When the analyzed pointer reaches the end of the remote-process-request massage, the access log analyzer 2211 escapes from the loop at S602, finishing the process. If the process based on the received remote-process-request massage succeeded, the access log analyzer 2211 sets a returned value to “regular”. If the process failed, the access log analyzer 2211 sets a returned value to “irregular”. The returned value is send to the remote-process routine 1231 through the communication process controller 2210 and the communication process controller 1234 (SQ48, SQ49, SQ50).

The remote-process routine 1231 checks whether the returned value from the communication process controller 1234 is “regular” or not (S404). If the returned value from the communication process controller 1234 is “regular”, the remote-process routine 1231 sets a returned value to the business application 122 to “regular” (S405, SQ51). On the other hand, the remote-process routine 1231 sets the returned value to the business application 122 to “irregular” if the returned value from the communication process controller 1234 is “irregular” (S406, SQ51).

The business application 122 requests the remote-process routine 1231 of the remote access client 123 to disconnect from the database when the returned value from the remote-process routine 1231 is “regular” (S007, SQ52). Then the remote-process routine 1231 requests the communication process controller 1234 to disconnect from the database (SQ53). The communication process controller 1234 transmits the remote-process-request message whose process type is a “disconnection request” to the data server 221 (SQ54). The communication process controller 2210 of the data server 221 that received the remote-process-request message passes the massage to the DML processor 2212 (SQ55). The DML processor 2212 that received the remote-process-request message issues an appropriate DML instruction to close the database, committing the transaction of the database process (SQ56). A regular completion of all processes sets a returned value from the business application 122 corresponding to the disconnection request to “regular”. On the other hand, detection of irregularity cancels the transaction to disable the manipulations to the database, setting a returned value from the business application 122 corresponding to the disconnection request to “irregular”.

At last, the business application 122 informs whether the process finished regularly or not to the graphic application 121 based on the returned value from the remote-process routine 1231 (SQ57). The graphic application 121 makes the browser 33 display a processing-result-indication screen SC11 that describes whether the processes finished regularly or not (SQ58).

Further descriptions of the table shown in FIG. 16 that is referred by the access log manager 1232 during registration of a log will be supplemented hereinafter.

A sample case where a manipulation type by a data manipulation routine (access code) with respect to the database object in process (manipulation type in process) is “update” and a manipulation type in a registered log with respect to the same database object (registered manipulation type) is also “update” is as follows. Assuming that a record having the product code “101”, the warehouse number “1010” and the quantity of stock “500” is stored in a database object. The sample case is to reduce the quantity of stock from “500” to “400” in the record and then to change the warehouse number from “1010” to “1040” in the same record. In such a case, since the address of the database object is not changed, the access log manager 1232 is not required to register a new log. The access code only updates the database object of the record.

A sample case where a manipulation type by a data manipulation routine (access code) with respect to the database object in process (manipulation type in process) is “update” and a manipulation type in a registered log with respect to the same database object (registered manipulation type) is “insertion” is as follows. The sample case is to add a new record having the product code “102”, the warehouse number “1030” and the quantity of stock “1000” and then to change the warehouse number from “1030” to “1020” in the same record. In such a case, since the address of the database object is not changed, the access log manager 1232 is not required to register a new log. The access code only updates the database object of the record.

A sample case where a manipulation type by a data manipulation routine (access code) with respect to the database object in process (manipulation type in process) is “deletion” and a manipulation type in a registered log with respect to the same database object (registered manipulation type) is “update” is as follows. Assuming that a record having the product code “101”, the warehouse number “1010” and the quantity of stock “500” is stored in a database object. The sample case is to reduce the quantity of stock from “500” to “400” in the record and then to delete the same record. In such a case, the access log manager 1232 abandons the registered log whose manipulation type is “update” and registers a new log whose manipulation type is “deletion”.

A sample case where a manipulation type by a data manipulation routine (access code) with respect to the database object in process (manipulation type in process) is “deletion” and a manipulation type in a registered log with respect to the same database object (registered manipulation type) is “insertion” is as follows. The sample case is to add a record having the product code “102”, the warehouse number “1030” and the quantity of stock “1000” and then to delete the same record. In such a case, the access log manager 1232 cancels the registered log (the manipulation type is “insertion”), however, a new log is not registered because the record corresponding to the log is not exist in the database.

On the other hand, when a manipulation type by a data manipulation routine (access code) with respect to the database object in process (manipulation type in process) is “insertion”, a registered log with respect to the same database object (registered manipulation type) cannot exist. If there is a registered log, the access log manager 1232 judges the process sequence wrong, executing an error process.

In the same manner, since a manipulation type of a registered log with respect to the database object in process (registered manipulation type) cannot be “deletion”, the access log manager 1232 judges the process sequence wrong, executing an error process in such a case.

According to this embodiment, only one log is registered at the maximum (no log remains in some cases) no matter how complicated the data manipulation of the business application 122 is. Therefore, only one log-unit-encode information at the maximum is stored in a remote-process-request message for a reflection request about each database object and the DML processor 2212 executes one data manipulation at the maximum for each record of the database, which enables to achieve high-speed remote database access.

The data manipulation persisting method in a transaction processing system of the present invention enables to minimize communication (giving and receiving of request massages and results of processes) between an application and a data server until a persistence of a database object regardless of contents of a business operation, which results in a high-speed, high-performance access to a remote database from a business application.

What is claimed is:

1. A method for persisting data manipulations in a transaction processing system that consists of a first computer system issuing a data manipulation request to a database having a plurality of records and a second computer system accessing said database according to said data manipulation request, said method comprising:
a step where said first computer system designates a search condition, requesting said second computer system to retrieve records that satisfy said search condition from said database; a step where said second computer system retrieves all records that satisfy said search condition designated by said first computer system from said database, sending the contents thereof back to said first computer system;
a step where said first computer system executes preset data manipulations on a memory to said database object, which corresponds to contents of records retrieved by said second computer system, recording the contents of said data manipulations into said memory as a log by a record;
a step where said first computer system stores the contents of said database object and said log after the data manipulations into a message, sending the message to the second computer system when all of said preset data manipulations to the database object are completed; and
a step where said second computer system accesses said database according to the contents of said log in said message received from said first computer system and the second computer system reflects said database object to said database.

2. The data manipulation persisting method in a transaction processing system according to claim 1, wherein said first computer system only stores the database object whose contents are updated by said data manipulations and the database object that is added by said data manipulation in said massage to send it to the second computer system.

3. The data manipulation persisting method in a transaction processing system according to claim 1, wherein said first computer system stores contents of a database object after the final data manipulation in said message to send it to said second computer system when a plurality of data manipulations were executed for said database object.

4. The data manipulation persisting method in a transaction processing system according to claim 3, wherein said first computer system stores contents of only one log, which is needed to reflect said database object stored in said massage to said database, in said message when a plurality of data manipulations were executed for said database object.

5. The data manipulation persisting method in a transaction processing system according to claim 4, wherein said first computer system stores one update log and contents after the final update in said massage with respect to a predetermined database object when update was repeated to said database object.

6. The data manipulation persisting method in a transaction processing system according to claim 4, wherein said first computer system stores one insertion log and contents after the update in a message with respect to a predetermined database object when update was executed after insertion for said database object.

7. The data manipulation persisting method in a transaction processing system according to claim 4, wherein said first computer system stores one deletion log in said massage and does not store contents with respect to a predetermined database object when deletion was executed after update for said database object.

8. The data manipulation persisting method in a transaction processing system according to claim 4, wherein said first computer system does not store a log and contents with respect to a predetermined database object when deletion was executed after insertion for said database object.

9. A data manipulating program for a remote database comprising:
a first step where a client computer, which communicates with a server computer accessing a database to execute transaction for said database, designates a search condition, requesting said server computer to retrieve records that satisfy said search condition from said database;
a second step where said client computer executes preset data manipulations on a memory to an database object, which corresponds to contents of the records retrieved by said server computer, recording the contents of the data manipulations into said memory as a log by a record; and
a third step where said client computer stores the contents of said database object and said log after said data manipulations into a message, sending said message to said server computer, thereby requesting to reflect said database object to said database when all of said preset data manipulations to said database object are completed.

10. The data manipulating program for a remote database according to claim 9, wherein modules that make said client computer execute said first and second steps are programmed to vary from one business content to another, and wherein a module that makes said client computer execute said third step is programmed to be common to all business contents.
